(19) United States
(12) Patent Application Publication
(10) Pub. No.: US 2019/0210336 A1
(43) Pub. Date: Jul. 11, 2019

(54) LAMINATE FOR DIMENSIONALLY STABLE FOODSTUFF CONTAINERS HAVING AN OUTER POLYMER LAYER WITH A REFLECTANCE

(71) Applicant: SIG TECHNOLOGY AG, Neuhausen am Rheinfall (CH)

(72) Inventors: Dirk SCHIBULL, Hückelhoven Baal (DE); Alexander PAULING, Jüchen (DE); Sven JOEKEN, Düren (DE); Daniel ESSER, Herzogenrath (DE)

(21) Appl. No.: 16/302,861

(22) PCT Filed: May 23, 2017
(86) PCT No.: PCT/EP2017/062449

§ 371 Date: Nov. 19, 2018

(30) Foreign Application Priority Data
May 31, 2016 (DE) 10 2016 209 434.3
Apr. 6, 2017 (DE) 10 2017 205 928.1

(51) Int. Cl. B32B 27/18; B32B 27/30; B32B 27/34; B32B 27/32; B32B 27/10; B32B 15/20

(52) U.S. Cl. CPC B32B 27/18; B32B 27/306; B32B 27/34; B32B 27/327; B32B 27/10; B32B 15/20; B32B 15/082; B32B 2264/108; B32B 2307/7244; B32B 2307/416; B32B 2307/7248; B32B 2439/70; B32B 2264/102

(57) ABSTRACT

The invention relates to a sheetlike composite comprising, as layers of a layer sequence, from an outer face of the sheetlike composite to an inner face of the sheetlike composite, a) an outer polymer layer comprising i) a polymer matrix, and ii) a multitude of inorganic particles; b) a carrier layer; c) a barrier layer; and d) an inner polymer layer; wherein the outer polymer layer superposed on the carrier layer is characterized by a reflectance for a reflection of light having a wavelength in a range from 600 to 800 nm in a range from 4% to 8%. The invention further relates to a container precursor and to a closed container comprising the sheetlike composite and to a method by which the sheetlike composite is obtainable, to a method by which a container is obtainable, and to a method by which a filled and closed container is obtainable, and to a use of the sheetlike composite.

The invention relates to a sheetlike composite comprising, as layers of a layer sequence, from an outer face of the sheetlike composite to an inner face of the sheetlike composite,
a) an outer polymer layer comprising
   i) a polymer matrix, and
   ii) a multitude of inorganic particles;
b) a carrier layer;
c) a barrier layer; and
d) an inner polymer layer;
   wherein the outer polymer layer superposed on the carrier layer is characterized by a reflectance for a reflection of light having a wavelength in a range from 600 to 800 nm according to the test method described herein in a range from 4% to 8%. The invention further relates to a container precursor and to a closed container comprising the sheetlike composite and to a method by which the sheetlike composite is obtainable, to a method by which a container is obtainable, and to a method by which a filled and closed container is obtainable, and to a use of the sheetlike composite.

For some time, foodstuffs, whether they be foodstuffs for human consumption or else animal feed products, have been preserved by storing them either in a can or in a jar closed by a lid. In this case, shelf life can be increased firstly by separately and as far as possible sterilizing the foodstuff and the container in each case, here the jar or can, and then introducing the foodstuff into the container and closing the container. However, these measures of increasing the shelf life of foodstuffs, which have been tried and tested over a long period, have a series of disadvantages, for example the need for another sterilization later on. Cans and jars, because of their essentially cylindrical shape, have the disadvantage that very dense and space-saving storage is not possible. Moreover, cans and jars have considerable intrinsic weight, which leads to increased energy expenditure in transport. In addition, production of glass, tinplate or aluminium, even when the raw materials used for the purpose are recycled, necessitates quite a high expenditure of energy. In the case of jars, an additional aggravating factor is elevated expenditure on transport. The jars are usually prefabricated in a glass factory and then have to be transported to the facility where the foodstuffs are dispensed with utilization of considerable transport volumes. Furthermore, jars and cans can be opened only with considerable expenditure of force or with the aid of tools and hence in a rather laborious manner. In the case of cans, there is a high risk of injury emanating from sharp edges that arise on opening. In the case of jars, it occurs again and again that broken glass gets into the foodstuff in the course of filling or opening of the filled jars, which can lead in the worst case to internal injuries on consumption of the foodstuff. In addition, both cans and jars have to be labelled for identification and promotion of the foodstuff contents. The jars and cans cannot readily be printed directly with information and promotional messages. In addition to the actual printing, a substrate is thus needed for the purpose, a paper or suitable film, as is a securing means, an adhesive or sealant.

Other packaging systems are known from the prior art, in order to store foodstuffs over a long period with minimum impairment. These are containers produced from sheetlike composites—frequently also referred to as laminates. Sheetlike composites of this kind are frequently constructed from a thermoplastic polymer layer, a carrier layer usually consisting of paperboard or paper which imparts dimensional stability to the container, an adhesion promoter layer, a barrier layer and a further polymer layer, as disclosed inter alia in WO 90/09926 A2. Since the carrier layer imparts dimensional stability to the container manufactured from the laminate, these containers, in contrast to foil bags, can be regarded as a further development of the aforementioned jars and cans.

In addition, packaging systems with a proportion of light-absorbing and/or light-reflecting fillers are likewise known, for example from EP 1089877 B1. Here, light-absorbing filler based on carbon powder has been incorporated in an inner layer of a composite material. Since large amounts of carbon powder are required for the light barrier, such composite materials then have a grey appearance. EP 1089877 A1 asserts that incorporation of a light-reflecting mineral powder into one of the outer layers of the composite material attenuates this grey effect.

Laminate containers produced from the aforementioned packaging systems already have many advantages over the conventional jars and cans. Nevertheless, there are opportunities for improvement in the case of these packaging systems too.

In general terms, it is an object of the present invention to at least partly overcome a disadvantage that arises from the prior art. It is an object of the invention to provide a packaging material laminate for production of a dimensionally stable foodstuff container which gives a metallic impression to a high degree. Preferably, such impressions are considered to be what are called special optical effects, especially significant gloss and glitter effects with a depth effect. It is a further object of the invention to provide a packaging material laminate for production of a dimensionally stable foodstuff container having improved printability.

It is a further object of the invention to provide packaging material laminates for production of dimensionally stable foodstuff containers with improved barrier properties, especially with respect to moisture and oxygen. It is a further object of the invention to provide a packaging material laminate for production of a dimensionally stable foodstuff container, wherein the laminate has maximum thermal insulation. It is an additional object of the invention to provide a packaging material laminate for production of a dimensionally stable foodstuff container, wherein the container is particularly suitable for vitamin-containing foodstuff.

It is a further object of the invention to provide a packaging material laminate for production of dimensionally stable foodstuff containers, which has a minimum level of static charging in the course of processing. In addition, it is an object of the invention to provide a packaging material laminate for production of dimensionally stable foodstuff containers, wherein the container has better openability. It is a further object of the invention to provide a packaging material laminate having a combination of two or more of the above advantages. It is an additional object of the present invention to provide a container precursor and a container made from the aforementioned advantageous packaging material laminate.

A contribution to the at least partial achievement of at least one of the aforementioned objects is made by the independent claims. The dependent claims provide preferred embodiments which contribute to the at least partial achievement of at least one of the objects.

In the present description, specified ranges also include the values mentioned as limits. A statement of the kind “in the range from X to Y” in relation to a parameter A consequently means that A can assume the values of X, Y and values between X and Y. Ranges limited at one end of the kind “up to Y” for a parameter A correspondingly mean, as values, Y and less than Y.

A contribution to the achievement of at least one of the objects of the invention is made by an embodiment 1 of a sheetlike composite 1, comprising, as layers of a layer sequence, from an outer face of the sheetlike composite to an inner face of the sheetlike composite,
a) an outer polymer layer comprising
   i) a polymer matrix, and
   ii) a multitude of inorganic particles;
b) a carrier layer;
c) a barrier layer; and
d) an inner polymer layer;
   wherein the outer polymer layer superposed on the carrier layer is characterized by a reflectance for a reflection of light having a wavelength in a range from 600 to 800 nm according to the test method described herein in a range from 4% to 8%, preferably from 4.5% to 7.5%, more preferably from 5.0% to 7.0%, most preferably from 5.0% to 6.5%.

In one embodiment 2 of the invention, the sheetlike composite 1 is configured according to embodiment 1, wherein the outer polymer layer is characterized by a grammage in a range from 5 to 75 g/m², preferably from 6 to 70 g/m², more preferably from 7 to 65 g/m², more preferably from 8 to 60 g/m², more preferably from 9 to 55 g/m², most preferably from 10 to 50 g/m².

In one embodiment 3 of the invention, the sheetlike composite 1 is configured according to embodiment 1 or 2, wherein the outer polymer layer comprises the multitude of inorganic particles in an overall proportion in a range from 1% to 15% by weight, preferably from 5% to 10% by weight, more preferably from 5% to 7.5% by weight, based in each case on the total weight of the outer polymer layer.

In one embodiment 4 of the invention, the sheetlike composite 1 is configured according to any of the preceding embodiments, wherein the multitude of inorganic particles comprises
a) a first kind of inorganic particles in a first proportion by weight, based on the total weight of the outer polymer layer, and
b) a further kind of inorganic particles in a further proportion by weight, based on the total weight of the outer polymer layer,
   where a ratio of the first proportion by weight to the further proportion by weight is in a range from 60:1 to 1000:1, preferably from 70:1 to 900:1, more preferably from 80:1 to 800:1.

In one embodiment 5 of the invention, the sheetlike composite 1 is configured according to embodiment 4, wherein the first proportion by weight is in a range from 1% to 15% by weight, preferably from 5% to 10% by weight, more preferably from 5% to 7.5% by weight, based in each case on the total weight of the outer polymer layer.

In one embodiment 6 of the invention, the sheetlike composite 1 is configured according to either of embodiments 4 and 5, wherein the further proportion by weight is in a range from 0.001% to 1% by weight, preferably in a range from 0.002% to 0.9% by weight, most preferably in a range from 0.003% to 0.8% by weight, based in each case on the total weight of the outer polymer layer.

In one embodiment 7 of the invention, the sheetlike composite 1 is configured according to any of embodiments 4 to 6, wherein the inorganic particles of the further kind are characterized by an absorptance in a range from 0.8 to 0.99, preferably from 0.85 to 0.99, more preferably from 0.9 to 0.99.

In one embodiment 8 of the invention, the sheetlike composite 1 is configured according to any of embodiments 4 to 7, wherein the inorganic particles of the further kind comprise carbon in a proportion of at least 50% by weight, preferably at least 60% by weight, more preferably at least 70% by weight, more preferably at least 80% by weight, more preferably at least 90% by weight, most preferably at least 95% by weight, based in each case on the weight of the inorganic particles of the further kind. Further preferably, the inorganic particles of the further kind are carbon particles. Preferred carbon particles are carbon black particles, activated carbon particles or a combination of the two.

In one embodiment 9 of the invention, the sheetlike composite 1 is configured according to any of embodiments 4 to 8, wherein the inorganic particles of the first kind each comprise a core and a shell superposed on the core.

In one embodiment 10 of the invention, the sheetlike composite 1 is configured according to embodiment 9, wherein the core of the inorganic particles of the first kind comprises a silicate or a silicon oxide or both.

In one embodiment 11 of the invention, the sheetlike composite 1 is configured according to either of embodiments 9 and 10, wherein the shell of the inorganic particles of the first kind comprises an oxide of a first metal other than silicon.

In a configuration of embodiment 11 which is preferred in accordance with the invention, the inorganic particles of the first kind comprise the oxide of the first metal other than silicon in a proportion in a range from 0.01% to 50% by weight, more preferably from 0.05% to 40% by weight, most preferably from 0.1% to 30% by weight, based in each case on the total weight of the inorganic particles of the first kind.

In a further configuration which is preferred in accordance with the invention, the shell of the inorganic particles of the first kind is transparent.

In one embodiment 12 of the invention, the sheetlike composite 1 is configured according to embodiment 11, wherein the oxide of the first metal other than silicon is characterized by a tetragonal crystal structure of the P4₂/mnm space group. The P4₂/mnm space group is also identified by the space group number 136. Preferably, the oxide of the first metal other than silicon is present in a rutile polymorph. Alternatively, an anatase polymorph or a combination of the two is additionally possible.

In one embodiment 13 of the invention, the sheetlike composite 1 is configured according to either of embodiments 11 and 12, wherein the shell of the inorganic particles of the first kind further comprises an oxide of a further metal other than silicon. The oxide of a further metal other than silicon is preferably a tin oxide. A preferred tin oxide is SnO₂.

In one embodiment 14 of the invention, the sheetlike composite 1 is configured according to any of embodiments 4 to 13, wherein the inorganic particles of the first kind are characterized by an aspect ratio of at least 2, preferably of at least 10 and more preferably of at least 50. However, the aspect ratio may also be up to 2000.

In one embodiment 15 of the invention, the sheetlike composite 1 is configured according to any of the preceding embodiments, wherein the outer polymer layer, on a side of the outer polymer layer remote from the carrier layer, has a superposed colour layer.

In one embodiment 16 of the invention, the sheetlike composite 1 is configured according to any of the preceding embodiments, wherein the sheetlike composite on the outer face is characterized by a gloss in a range from 25 to 70 GU, preferably from 30 to 70 GU, more preferably from 40 to 70 GU, even more preferably from 50 to 70 GU, most preferably from 60 to 70 GU.

In one embodiment 17 of the invention, the sheetlike composite 1 is configured according to any of the preceding embodiments, wherein the outer polymer layer is characterized by one or at least two of the following properties:
a transmittance
a) for light of wavelength 200 nm of less than 1%,
b) for light of wavelength 300 nm of less than 30%,
c) for light of wavelength 400 nm in a range from 15% to 40%,
d) for light of wavelength 500 nm in a range from 15% to 45%,
e) for light of wavelength 600 nm in a range from 20% to 45%,
f) for light of wavelength 700 nm in a range from 25% to 50%, and
g) for light of wavelength 800 nm in a range from 30% to 50%.

In one embodiment 18 of the invention, the sheetlike composite 1 is configured according to any of the preceding embodiments, wherein the polymer matrix comprises a polyolefin, preferably a polyethylene.

In one embodiment 19 of the invention, the sheetlike composite 1 is configured according to any of the preceding embodiments, wherein the barrier layer comprises one selected from the group consisting of a plastic, a metal and a metal oxide, or a combination of at least two thereof. The barrier layer preferably consists of one element from this group or of a combination of at least two thereof.

In one embodiment 20 of the invention, the sheetlike composite 1 is configured according to any of the preceding embodiments, wherein the inner polymer layer comprises a polymer prepared by means of a metallocene catalyst to an extent of 10% to 90% by weight, preferably to an extent of 25% to 90% by weight, more preferably to an extent of 30% to 80% by weight, based in each case on the total weight of the inner polymer layer.

In one embodiment 21 of the invention, the sheetlike composite 1 is configured according to any of the preceding embodiments, wherein the inner polymer layer comprises a polymer blend, wherein the polymer blend comprises an mPE to an extent of 10% to 90% by weight, preferably to an extent of 25% to 90% by weight, more preferably to an extent of 30% to 80% by weight, and a further polymer to an extent of at least 10% by weight, preferably to an extent of at least 15% by weight, more preferably to an extent of at least 20% by weight, based in each case on the total weight of the polymer blend.

In one embodiment 22 of the invention, the sheetlike composite 1 is configured according to any of the preceding embodiments, wherein the carrier layer comprises one selected from the group consisting of cardboard, paperboard and paper, or a combination of at least two thereof. The carrier layer preferably consists of one element from this group or of a combination of at least two thereof.

In one embodiment 23 of the invention, the sheetlike composite 1 is configured according to any of the preceding embodiments, wherein the carrier layer has at least one hole, wherein the hole is covered at least by the barrier layer and at least by the inner polymer layer as hole-covering layers.

A contribution to the achievement of at least one of the objects of the invention is made by an embodiment 1 of a container precursor 1 comprising the sheetlike composite 1 according to any of embodiments 1 to 23.

In one embodiment 2 of the invention, the container precursor 1 is configured according to embodiment 1, wherein the sheetlike composite comprises at least 3, preferably at least 4, more preferably at least 5 and most preferably at least 10 folds.

In one embodiment 3 of the invention, the container precursor 1 is configured according to embodiment 1 or 2, wherein the sheetlike composite comprises a first longitudinal edge and a further longitudinal edge, wherein the first longitudinal edge is joined to the further longitudinal edge thereby forming a longitudinal seam of the container precursor.

In one embodiment 4 of the invention, the container precursor 1 is configured according to any of embodiments 1 to 3, wherein the sheetlike composite is a blank for production of a single container.

A contribution to the achievement of at least one of the objects of the invention is made by an embodiment 1 of a closed container 1 comprising the sheetlike composite 1 according to any of embodiments 1 to 23.

In one embodiment 2 of the invention, the closed container 1 is configured according to embodiment 1, wherein the sheetlike composite comprises a first longitudinal edge and a further longitudinal edge, wherein the first longitudinal edge is joined to the further longitudinal edge thereby forming a longitudinal seam of the container precursor.

In one embodiment 3 of the invention, the closed container 1 is configured according to either of embodiments 1 and 2, wherein the closed container comprises a foodstuff.

A contribution to the achievement of at least one of the objects of the invention is made by an embodiment 1 of a method 1 comprising, as method steps,
a) providing a sheetlike composite precursor comprising, as layers of a layer sequence,
   i) a carrier layer, and
   ii) a barrier layer;
b) providing a first composition comprising, as constituents,
   i) a first amount of a polymer, and
   ii) a multitude of inorganic particles of a first kind;
c) providing a second composition comprising, as constituents,
   i) a second amount of the polymer, and
   ii) a multitude of inorganic particles of a further kind;
d) contacting the first composition and the second composition with a third amount of the polymer thereby obtaining a third composition; and
e) superposing the third composition on the carrier layer, on a side of the carrier layer remote from the barrier layer, thereby obtaining an outer polymer layer.

In a configuration which is preferred in accordance with the invention, the first composition, the further composition and the third amount of the polymer are mixed with one another in method step d). Preferably, the mixing in method step d) is effected in an extruder. A preferred method of superposition is extrusion.

in one embodiment 2 of the invention, the method 1 is configured according to the embodiment 1, wherein, in method step e), the third composition is superposed on the carrier layer in a grammage in a range from 5 to 75 g/m², preferably from 6 to 70 g/m², more preferably from 7 to 65 g/m², more preferably from 8 to 60 g/m², more preferably from 9 to 55 g/m², most preferably from 10 to 50 g/m².

In one embodiment 3 of the invention, the method 1 is configured according to either of embodiments 1 and 2, wherein the first composition comprises the inorganic particles of the first kind in a proportion in a range from 5% to 30% by weight, preferably from 5% to 25% by weight, more preferably from 10% to 20% by weight, based in each case on the total weight of the first composition.

In one embodiment 4 of the invention, the method 1 is configured according to any of embodiments 1 to 3, wherein the second composition comprises the inorganic particles of the further kind in a proportion in a range from 0.01% to 1.5% by weight, preferably from 0.05% to 1.2% by weight, more preferably from 0.1% to 1.0% by weight, more preferably from 0.2% to 1.0% by weight, based in each case on the total weight of the second composition.

In one embodiment 5 of the invention, the method 1 is configured according to any of embodiments 1 to 4, wherein the third composition comprises the inorganic particles of the first kind and the inorganic particles of the further kind in a total proportion in a range from 1% to 15% by weight, preferably from 5% to 10% by weight, more preferably from 5% to 7.5% by weight, based in each case on the total weight of the third composition.

In one embodiment 6 of the invention, the method 1 is configured according to any of embodiments 1 to 5, wherein the third composition comprises
A) the inorganic particles of the first kind in a first proportion by weight, based on the total weight of the third composition, and
B) the inorganic particles of the further kind in a further proportion by weight, based on the total weight of the third composition;

where a ratio of the first proportion by weight to the further proportion by weight is in a range from 60:1 to 1000:1, preferably from 70:1 to 900:1, more preferably from 80:1 to 800:1.

In one embodiment 7 of the invention, the method 1 is configured according to embodiment 6, wherein the first proportion by weight is in a range from 1% to 15% by weight, preferably from 2% to 14% by weight, more preferably from 3% to 13% by weight, based in each case on the total weight of the third composition.

In one embodiment 8 of the invention, the method 1 is configured according to either of embodiments 6 and 7, wherein the further proportion by weight is in a range from 0.001% to 1% by weight, preferably in a range from 0.002% to 0.9% by weight, most preferably in a range from 0.003% to 0.8% by weight, based in each case on the total weight of the third composition.

In one embodiment 9 of the invention, the method 1 is configured according to any of embodiments 1 to 8, wherein the inorganic particles of the further kind are characterized by an absorptance in a range from 0.8 to 0.99, preferably from 0.85 to 0.99, more preferably from 0.9 to 0.99.

In one embodiment 10 of the invention, the method 1 is configured according to any of embodiments 1 to 9, wherein the inorganic particles of the further kind comprise carbon in a proportion of at least 50% by weight, preferably at least 60% by weight, more preferably at least 70% by weight, more preferably at least 80% by weight, more preferably at least 90% by weight, most preferably at least 95% by weight, based in each case on the weight of the inorganic particles of the further kind.

In one embodiment 11 of the invention, the method 1 is configured according to any of embodiments 1 to 10, wherein the inorganic particles of the first kind each comprise a core and a shell superposed on the core.

In one embodiment 12 of the invention, the method 1 is configured according to embodiment 10, wherein the core of the inorganic particles of the first kind comprises a silicate or a silicon oxide or both.

In one embodiment 13 of the invention, the method 1 is configured according to either of embodiments 11 and 12, wherein the shell of the inorganic particles of the first kind comprises an oxide of a first metal other than silicon.

In a configuration of embodiment 13 which is preferred in accordance with the invention, the inorganic particles of the first kind comprise the oxide of the first metal other than silicon in a proportion in a range from 0.01% to 50% by weight, more preferably from 0.05% to 40% by weight, most preferably from 0.1% to 30% by weight, based in each case on the total weight of the inorganic particles of the first kind.

In a further configuration which is preferred in accordance with the invention, the shell of the inorganic particles of the first kind is transparent.

In one embodiment 14 of the invention, the method 1 is configured according to embodiment 13, wherein the oxide of the first metal other than silicon is characterized by a tetragonal crystal structure of the P4₂/mnm space group. The P4₂/mnm space group is also identified by the space group number 136. Preferably, the oxide of the first metal other than silicon is present in a rutile polymorph. Alternatively, an anatase polymorph or a combination of the two is additionally possible.

In one embodiment 15 of the invention, the method 1 is configured according to either of embodiments 13 and 14, wherein the shell of the inorganic particles of the first kind further comprises an oxide of a further metal other than silicon. The oxide of a further metal other than silicon is preferably a tin oxide. A preferred tin oxide is SnO₂.

In one embodiment 16 of the invention, the method 1 is configured according to any of embodiments 1 to 15, wherein the inorganic particles of the first kind are characterized by an aspect ratio of at least 2, preferably of at least 10 and particularly preferable of at least 50. However, the aspect ratio may also be up to 2000.

In one embodiment 17 of the invention, the method 1 is configured according to any of embodiments 1 to 16, wherein the polymer is a polyolefin, preferably a polyethylene.

In one embodiment 18 of the invention, the method 1 is configured according to any of embodiments 1 to 17, wherein the method further comprises a method step f), wherein, in method step f), a colour layer is superposed on the outer polymer layer on a side of the outer polymer layer remote from the carrier layer. Preferably, the colour layer is superposed on the outer polymer layer in method step f) by an intaglio printing method.

A contribution to the achievement of at least one of the objects of the invention is made by an embodiment 1 of a sheetlike composite 2, obtainable by the method according to any of embodiments 1 to 18 of method 1.

A contribution to the achievement of at least one of the objects of the invention is made by an embodiment 1 of a method 2 comprising, as method steps,
A. providing the sheetlike composite 1 according to any of embodiments 1 to 23, comprising a first longitudinal edge and a further longitudinal edge;
B. folding the sheetlike composite; and
C. contacting and joining the first longitudinal edge to the further longitudinal edge thereby obtaining a longitudinal seam.

A contribution to the achievement of at least one of the objects of the invention is made by an embodiment 1 of a container precursor 2, obtainable by the method 2 according to embodiment 1.

A contribution to the achievement of at least one of the objects of the invention is made by an embodiment 1 of a method 3 comprising, as method steps,
a. providing the container precursor 1 according to any of embodiments 1 to 4 or a container precursor 2 according to embodiment 1;
b. forming a base region of the container precursor by folding the sheetlike composite;
c. closing the base region;
d. filling the container precursor with a foodstuff, and
e. closing the container precursor in a top region thereby obtaining a closed container.

In one embodiment 2 of the invention, the method 3 is configured according to its embodiment 1, wherein the method further comprises a method step of
f. joining the closed container to an opening aid.

A contribution to the achievement of at least one of the objects of the invention is made by an embodiment 1 of a closed container 2, obtainable by embodiment 1 or 2 of method 3.

A contribution to the achievement of at least one of the objects of the invention is made by an embodiment 1 of a use 1 of the sheetlike composite 1 according to any of embodiments 1 to 23 for production of a closed container filled with a foodstuff.

A contribution to the achievement of at least one of the objects of the invention is made by an embodiment 1 of a use 2 of
a) a first composition comprising, as constituents,
   i) a first amount of a polymer, and
   ii) a multitude of inorganic particles of a first kind; and
b) a second composition comprising, as constituents,
   i) a second amount of the polymer, and
   ii) a multitude of inorganic particles of a further kind
      for production of a packaging material laminate for dimensionally stable foodstuff containers; wherein the first composition comprises the inorganic particles of the first kind in a proportion in a range from 5% to 30% by weight, preferably from 5% to 25% by weight, more preferably from 5% to 20% by weight, most preferably from 5% to 15% by weight, based in each case on the total weight of the first composition; wherein the second composition comprises the inorganic particles of the further kind in a proportion in a range from 0.01% to 1.5% by weight, preferably from 0.1% to 1.5% by weight, more preferably from 0.3% to 1.2% by weight, most preferably from 0.5% to 1.0% by weight, based in each case on the total weight of the second composition; wherein each of the inorganic particles of the first kind comprises a core comprising a silicate or a silicon oxide or both, and a shell superposed on the core, comprising an oxide of a first metal other than silicon; wherein the inorganic particles of the further kind comprise carbon in a proportion of at least 50% by weight, preferably at least 60% by weight, more preferably at least 70% by weight, more preferably at least 80% by weight, more preferably at least 90% by weight, most preferably at least 95% by weight, based in each case on the weight of the inorganic particles of the further kind.

Features described as preferred in one category of the invention are likewise preferred in an embodiment of the further categories of the invention.

### First Kind of Inorganic Particles

The inorganic particles of the first kind preferably comprise what are called effect pigments. Preferred effect pigments are selected from the group consisting of pearlescent pigments, interference pigments, metal effect pigments and multilayer pigments or a combination of at least two of these. Preferred multilayer pigments include one selected from the group of transparent layers, semitransparent layers and opaque layers or a combination of at least two of these. Further preferred effect pigments comprise a preferably platelet-shaped core. The core is also called the carrier. Suitable effect pigments are commercially available, for example from BASF Catalysts (formerly Engelhard Corporation), for example under the Firemist®, Rightfit™, Magnapearl® brand names, and from Merck KGaA under the Iriodin®, Miraval®, Xirallic®, Pyrisma® and Colorstream® brand names. The size of the effect pigments is not critical per se. Platelet-shaped carriers and/or platelet-shaped carriers coated with one or more transparent or semitransparent metal oxide, metal or metal fluoride layers generally have a thickness between 0.5 and 5 μm, especially between 0.1 and 4.5 μm. The extent in terms of length or width is typically between 1 and 250 μm, preferably between 2 and 200 μm and especially between 2 and 100 μm.

### Core (Carrier)

Preferably, the core of the inorganic particles of the first kind consists of a silicate or silicon oxide or a combination of the two. A preferred silicate is a sheet silicate. Suitable examples are TiO₂ in platelet form, synthetic (e.g. fluorophlogopite) or natural mica, doped or undoped glass platelets, metal platelets, SiO₂ in platelet form, Al₂O₃ or iron oxide in platelet form. The metal platelets may consist, inter alia, of aluminium, titanium, bronze, steel or silver, preferably aluminium or titanium or both. The metal platelets may be passivated by appropriate treatment. The glass platelets may consist of all types of glass known to the person skilled in the art, for example of A glass, E glass, C glass, ECR glass, used glass, window glass, borosilicate glass, Duran® glass, laboratory glass or optical glass. The refractive index of the glass platelets is preferably in a range from 1.45 to 1.80, more preferably from 1.50 to 1.70. More preferably, the glass substrates consist of one selected from the group consisting of C glass, ECR glass and borosilicate glass or of a combination of at least two of these.

### Shell

Preferably, the shell of the inorganic particles of the first kind consists of the oxide of a first metal other than silicon. A preferred oxide of a first metal other than silicon is selected from the group consisting of TiO₂, ZrO₂, SnO₂, Al₂O₃, FeTiO₃, Fe₂O₃ and Cr₂O₃ or a combination, especially also mixed oxides, of at least two of these. The TiO₂ is preferably in a rutile polymorph or in an anatase polymorph or in a combination of the two. Preferred Fe₂O₃ is haematite.

In a preferred embodiment, the carrier may be coated with one or more transparent, semitransparent and/or opaque layers (shell) comprising metal oxides, metal oxide hydrates, metal suboxides, metals, metal fluorides, metal nitrides, metal oxynitrides or mixtures of these materials. The metal oxide, metal oxide hydrate, metal suboxide, metal, metal fluoride, metal nitride, metal oxynitride layers or the mixtures thereof may have a low refractive index (<1.8) or a high refractive index (>1.8). Suitable metal oxides and metal oxide hydrates are all metal oxides or metal oxide hydrates known to those skilled in the art, for example aluminium oxide, aluminium oxide hydrate, silicon oxide, silicon oxide hydrate, iron oxide, tin oxide, cerium oxide, zinc oxide, zirconium oxide, chromium oxide, titanium oxide, especially titanium dioxide, titanium oxide hydrate and mixtures thereof, for example ilmenite or pseudobrookite. The metal suboxides used may, for example, be the titanium suboxides. Suitable metals are, for example, chromium, aluminium, nickel, silver, gold, titanium, copper or alloys; an example of a suitable metal fluoride is magnesium fluoride. Metal nitrides or metal oxynitrides used may, for example, be the nitrides or oxynitrides of the metals titanium, zirconium and/or tantalum. Preferably, metal oxide, metal, metal fluoride and/or metal oxide hydrate layers and most preferably metal oxide and/or metal oxide hydrate layers are applied to the carrier. In addition, it is also possible for multilayer structures composed of metal oxide, metal oxide hydrate, metal or metal fluoride layers of high and low refractive index to be present, in which case there is preferably alternation of layers of high and low refractive index. Especially preferred are layer assemblies composed of a layer of high refractive index and one of low refractive index, where one or more of these layer assemblies may have been applied to the carrier. The sequence of the layers of high and low refractive index may be matched to the carrier, in order to incorporate the carrier into the multilayer structure. In a further embodiment, the metal oxide, metal oxide hydrate, metal suboxide, metal, metal fluoride, metal nitride and metal oxynitride layers may be admixed or doped with colourants or other elements. Suitable colourants or other elements are, for example, organic or inorganic colour pigments such as coloured metal oxides, e.g. magnetite, chromium oxide, or colour pigments, for example Prussian blue, ultramarine, bismuth vanadate, cobalt blue, or else organic colour pigments, for example indigo, azo pigments, phthalocyanines or else carmine red or elements, for example yttrium or antimony. Effect pigments comprising these layers show high colour variety in relation to their body colour and can in many cases exhibit an angle-dependent change in colour (colour flop) as a result of interference. In a preferred embodiment, the outer layer on the carrier is a metal oxide of high refractive index. This outer layer may additionally be part of a layer assembly in the abovementioned layer assemblies or in the case of carriers of high refractive index and may consist, for example, of TiO₂, titanium suboxides, Fe₂O₃, SnO₂, ZnO, ZrO₂, Ce₂O₃, CoO, Co₃O₄, V₂O₅, Cr₂O₃ and/or mixtures thereof, for example ilmenite or pseudobrookite. TiO₂ is particularly preferred, as is Fe₂O₃. If the carrier platelets have been coated with TiO₂, the TiO₂ is preferably in the rutile polymorph, and further preferably in the anatase polymorph.

A “high” refractive index herein is to be regarded as one of not less than 1.8. A “low” refractive index herein is to be regarded as one of less than 1.8.

### Aspect Ratio

The aspect ratio of a three-dimensional article, especially of a platelet-shaped article, describes the ratio between the greatest extent (length) and the smallest extent (thickness) of the article on assessment in three Cartesian spatial directions. The extent in the third spatial direction is generally much less than the two other greater extents and is referred to as the thickness. The plane formed by the two greatest extents (length and width) of the article is referred to as the platelet plane.

In a configuration which is preferred in accordance with the invention, the inorganic particles of the first kind are in platelet form. Preferably, the inorganic particles of the first kind in platelet form have a thickness in a range from 0.05 to 5 μm, more preferably from 0.1 to 4.5 μm. The length of the inorganic particles of the first kind is preferably in a range from 1 to 250 μm, more preferably from 2 to 200 μm and most preferably from 2 to 100 μm.

### Layers of the Sheetlike Composite

Two layers are joined to one another when their adhesion to one another extends beyond van-der-Waals attraction forces. Layers that have been joined to one another preferably belong to a category selected from the group consisting of sealed to one another, glued to one another and compressed to one another, or a combination of at least two of these. Unless stated otherwise, in a layer sequence, the layers may follow one another indirectly, i.e. with one or at least two intermediate layers, or directly, i.e. with no intermediate layer. This is the case especially in the wording where one layer covers another layer. A wording where a layer sequence comprises enumerated layers means that at least the layers specified are present in the sequence specified. This wording does not necessarily mean that these layers follow on directly from one another. A wording where two layers adjoin one another means that these two layers follow one another directly and hence with no intermediate layer. However, this wording does not say anything about whether the two layers are joined to one another or not. Instead, these two layers may be in contact with one another.

### Polymer Layers

The term “polymer layer” refers hereinafter especially to the inner polymer layer, the outer polymer layer and the intermediate polymer layer. An intermediate polymer layer refers here to a polymer layer between the carrier layer and the barrier layer. A preferred polymer is a polyolefin. The polymer layers may have further constituents. The polymer layers are preferably introduced into or applied to the sheetlike composite material in an extrusion method. The further constituents of the polymer layers are preferably constituents that do not adversely affect the behaviour of the polymer melt on application as a layer. The further constituents may, for example, be inorganic compounds, such as metal salts, or further plastics, such as further thermoplastics. However, it is also conceivable that the further constituents are fillers or pigments, for example carbon black or metal oxides. Suitable thermoplastics for the further constituents especially include those that are readily processible by virtue of good extrusion characteristics. Among these, polymers obtained by chain polymerization are suitable, especially polyesters or polyolefins, particular preference being given to cyclic olefin copolymers (COCs), polycyclic olefin copolymers (POCs), especially polyethylene and polypropylene, and very particular preference to polyethylene. Among the polyethylenes, preference is given to HDPE (high density polyethylene), MDPE (medium density polyethylene), LDPE (low density polyethylene), LLDPE (linear low density polyethylene), VLDPE (very low density polyethylene) and PE (polyethylene), and mixtures of at least two thereof. It is also possible to use mixtures of at least two thermoplastics. Suitable polymer layers have a melt flow rate (MFR) in a range from 1 to 25 g/10 min, preferably in a range from 2 to 20 g/10 min and more preferably in a range from 2.5 to 15 g/10 min, and a density in a range from 0.890 g/cm³ to 0.980 g/cm³, preferably in a range from 0.895 g/cm³ to 0.975 g/cm³, and further preferably in a range from 0.900 g/cm³ to 0.970 g/cm³. The polymer layers preferably have at least one melting temperature in a range from 80 to 155° C., preferably in a range from 90 to 145° C. and more preferably in a range from 95 to 135° C.

### Inner Polymer Layer

The inner polymer layer is based on thermoplastic polymers, where the inner polymer layer may include a particulate inorganic solid. However, it is preferable that the inner polymer layer comprises a thermoplastic polymer to an extent of at least 70% by weight, preferably at least 80% by weight and more preferably at least 95% by weight, based in each case on the total weight of the inner polymer layer. Preferably, the polymer or polymer mixture of the inner polymer layer has a density (according to ISO 1183-1:2004) in a range from 0.900 to 0.980 g/cm³, more preferably in a range from 0.900 to 0.960 g/cm³ and most preferably in a range from 0.900 to 0.940 g/cm³.

### Carrier Layer

The carrier layer used may be any material which is suitable for a person skilled in the art for this purpose and which has sufficient strength and stiffness to impart stability to the container to such an extent that the container in the filled state essentially retains its shape. This is, in particular, a necessary feature of the carrier layer since the invention relates to the technical field of dimensionally stable containers. As well as a number of plastics, preference is given to plant-based fibrous materials, especially pulps, preferably sized, bleached and/or unbleached pulps, paper and paperboard being especially preferred. The grammage of the carrier layer is preferably in a range from 120 to 450 g/m², especially preferably in a range from 130 to 400 g/m² and most preferably in a range from 150 to 380 g/m². A preferred paperboard generally has a single-layer or multilayer structure and may have been coated on one or both sides with one or else more than one cover layer. In addition, a more preferred paperboard has a residual moisture content of less than 20% by weight, preferably of 2% to 15% by weight and especially preferably of 4% to 10% by weight, based on the total weight of the paperboard. A more particularly preferred paperboard has a multilayer structure. Further preferably, the paperboard has, on the surface facing the environment, at least one lamina, but more preferably at least two laminas, of a cover layer known to the person skilled in the art as a “paper coating”. In addition, a more preferred paperboard has a Scott bond value in a range from 100 to 360 J/m², preferably from 120 to 350 J/m² and especially preferably from 135 to 310 J/m². By virtue of the aforementioned ranges, it is possible to provide a composite from which it is possible to fold a container with high integrity, easily and in low tolerances.

### Barrier Layer

The barrier layer used may be any material which is suitable for a person skilled in the art for this purpose and which has sufficient barrier action, especially with respect to oxygen. The barrier layer is preferably selected from
a. a plastic barrier layer;
b. a metal layer;
c. a metal oxide layer; or
d. a combination of at least two of a. to c.

If the barrier layer, according to alternative a., is a plastic r barrier layer, this preferably comprises at least 70% by weight, especially preferably at least 80% by weight and most preferably at least 95% by weight of at least one plastic which is known to the person skilled in the art for this purpose, especially for aroma or gas barrier properties suitable for packaging containers. Useful plastic, especially thermoplastics, here include N- or O-bearing plastic, either alone or in mixtures of two or more. According to the invention, it may be found to be advantageous when the plastic barrier layer has a melting temperature in a range from more than 155 to 300° C., preferably in a range from 160 to 280° C. and especially preferably in a range from 170 to 270° C.

Further preferably, the plastic barrier layer has a grammage in a range from 2 to 120 g/m², preferably in a range from 3 to 60 g/m², especially preferably in a range from 4 to 40 g/m² and further preferably from 6 to 30 g/m². Further preferably, the plastic barrier layer is obtainable from melts, for example by extrusion, especially laminar extrusion. Further preferably, the plastic barrier layer may also be introduced into the sheetlike composite via lamination. It is preferable in this context that a film is incorporated into the sheetlike composite. In another embodiment, it is also possible to select plastic barrier layers obtainable by deposition from a solution or dispersion of plastic s.

Suitable polymers preferably include those having a weight-average molecular weight, determined by gel permeation chromatography (GPC) by means of light scattering, in a range from 3·10³ to 1·10⁷ g/mol, preferably in a range from 5·10³ to 1·10⁶ g/mol and especially preferably in a range from 6·10³ to 1·10⁵ g/mol. Suitable polymers especially include polyamide (PA) or polyethylene vinyl alcohol (EVOH) or a mixture thereof.

Among the polyamides, useful PAs are all of those that seem suitable to the person skilled in the art for the use according to the invention. Particular mention should be made here of PA 6, PA 6.6, PA 6.10, PA 6.12, PA 11 or PA 12 or a mixture of at least two thereof, particular preference being given to PA 6 and PA 6.6 and further preference to PA 6. PA 6 is commercially available, for example, under the Akulon®, Durethan® and Ultramid® trade names. Additionally suitable are amorphous polyamides, for example MXD6, Grivory® and Selar® PA. It is further preferable that the PA has a density in a range from 1.01 to 1.40 g/cm³, preferably in a range from 1.05 to 1.30 g/cm³ and especially preferably in a range from 1.08 to 1.25 g/cm³. It is further preferable that the PA has a viscosity number in a range from 130 to 250 ml/g and preferably in a range from 140 to 220 ml/g.

Useful EVOHs include all the EVOHs that seem suitable to the person skilled in the art for the use according to the invention. Examples of these are commercially available, inter alia, under the EVAL™ trade names from EVAL Europe NV, Belgium, in a multitude of different versions, for example the EVAL™ F104B or EVAL™ LR171B types. Preferred EVOHs have at least one, two, more than two or all of the following properties:
an ethylene content in a range from 20 to 60 mol %, preferably from 25 to 45 mol %;
a density in a range from 1.0 to 1.4 g/cm³, preferably from 1.1 to 1.3 g/cm³;
a melting point in a range from more than 155 to 235° C., preferably from 165 to 225° C.;
an MFR value (210° C./2.16 kg when T_{S(EVOH)}<230° C.; 230° C./2.16 kg when 210° C.<T_{S(EVOH)}<230° C.) in a range from 1 to 25 g/10 min, preferably from 2 to 20 g/10 min;
an oxygen permeation rate in a range from 0.05 to 3.2 cm³·20 μm/m²·day·atm, preferably in a range from 0.1 to 1 cm³·20 μm/m²·day·atm.

Preferably at least one polymer layer, further preferably the inner polymer layer, or preferably all polymer layers, have a melting temperature below the melting temperature of the barrier layer. This is especially true when the barrier layer is formed from polymer. In this case, the melting temperatures of the at least one polymer layer, especially the inner polymer layer, and the melting temperature of the barrier layer differ preferably by at least 1 K, especially preferably by at least 10 K, even more preferably by at least 50 K, further preferably at least 100 K. The temperature difference should preferably be chosen only such that it is sufficiently high that there is no melting of the barrier layer, especially no melting of the plastic barrier layer, during the folding.

According to alternative b., the barrier layer is a metal layer. Suitable metal layers are in principle all layers comprising metals which are known to the person skilled in the art and which can provide high light opacity and oxygen impermeability. In a preferred embodiment, the metal layer may take the form of a foil or a deposited layer, for example after a physical gas phase deposition. The metal layer is preferably an uninterrupted layer. In a further preferred embodiment, the metal layer has a thickness in a range from 3 to 20 μm, preferably in a range from 3.5 to 12 μm and especially preferably in a range from 4 to 10 μm.

Metals selected with preference are aluminium, iron or copper. A preferred iron layer may be a steel layer, for example in the form of a foil. Further preferably, the metal layer is a layer comprising aluminium. The aluminium layer may appropriately consist of an aluminium alloy, for example AlFeMn, AlFe1.5Mn, AlFeSi or AlFeSiMn. The purity is typically 97.5% or higher, preferably 98.5% or higher, based in each case on the overall aluminium layer. In a preferred configuration, the metal layer consists of an aluminium foil. Suitable aluminium foils have a ductility of more than 1%, preferably of more than 1.3% and especially preferably of more than 1.5%, and a tensile strength of more than 30 N/mm², preferably more than 40 N/mm² and especially preferably more than 50 N/mm². Suitable aluminium foils in the pipette test show a droplet size of more than 3 mm, preferably more than 4 mm and especially preferably of more than 5 mm. Suitable alloys for creation of aluminium layers or foils are commercially available under the EN AW 1200, EN AW 8079 or EN AW 8111 names from Hydro Aluminium Deutschland GmbH or Amcor Flexibles Singen GmbH. In the case of a metal foil as barrier layer, it is possible to provide an adhesion promoter layer between the metal foil and a closest polymer layer on one or both sides of the metal foil.

Further preferably, the barrier layer selected, according to alternative c., may be a metal oxide layer. Useful metal oxide layers include all metal oxide layers that are familiar and seem suitable to the person skilled in the art, in order to achieve a barrier effect with respect to light, vapour and/or gas. Especially preferred are metal oxide layers based on the metals already mentioned above, aluminium, iron or copper, and those metal oxide layers based on titanium oxide or silicon oxide compounds. A metal oxide layer is produced by way of example by vapour deposition of metal oxide on a polymer layer, for example an oriented polypropylene film. A preferred method for this purpose is physical gas phase deposition.

In a further preferred embodiment, the metal layer of the metal oxide layer may take the form of a layer composite composed of one or more polymer layers with a metal layer. Such a layer is obtainable, for example, by vapour deposition of metal on a polymer layer, for example an oriented polypropylene film. A preferred method for this purpose is physical gas phase deposition.

### Outer Face

The outer face of the sheetlike composite is a surface of a ply of the sheetlike composite which is intended to be in contact with the environment of the container in a container to be produced from the sheetlike composite. This does not oppose that in individual regions of the container, outer faces of various regions of the composite are folded onto one another or joined to one another, for example sealed to one another.

### Inner Face

The inner face of the sheetlike composite is a surface of a ply of the sheetlike composite which is intended to be in contact with the contents of the container, preferably a foodstuff, in a container to be produced from the sheetlike composite.

### Adhesion/Adhesion Promoter Layer

An adhesion promoter layer may be present between layers which do not directly adjoin one another, preferably between the barrier layer and the inner polymer layer. Useful adhesion promoters in an adhesion promoter layer include all polymers which are suitable for producing a firm bond through functionalization by means of suitable functional groups, through the forming of ionic bonds or covalent bonds with a surface of a respective adjacent layer. Preferably, these comprise functionalized polyolefins which have been obtained by copolymerization of ethylene with acrylic acids such as acrylic acid, methacrylic acid, crotonic acid, acrylates, acrylate derivatives or carboxylic anhydrides that bear double bonds, for example maleic anhydride, or at least two of these. Among these, preference is given to polyethylene-maleic anhydride graft polymers (EMAH), ethylene-acrylic acid copolymers (EAA) or ethylene-methacrylic acid copolymers (EMAA), which are sold, for example, under the Bynel® and Nucrel®0609HSA trade names by DuPont or Escor®6000ExCo by ExxonMobil Chemicals.

According to the invention, it is preferable that the adhesion between a carrier layer, a polymer layer or a barrier layer and the next layer in each case is at least 0.5 N/15 mm, preferably at least 0.7 N/15 mm and especially preferably at least 0.8 N/15 mm. In one configuration according to the invention, it is preferable that the adhesion between a polymer layer and a carrier layer is at least 0.3 N/15 mm, preferably at least 0.5 N/15 mm and especially preferably at least 0.7 N/15 mm. It is further preferable that the adhesion between a barrier layer and a polymer layer is at least 0.8 N/15 mm, preferably at least 1.0 N/15 mm and especially preferably at least 1.4 N/15 mm. If a barrier layer indirectly follows a polymer layer with an adhesion promoter layer in between, it is preferable that the adhesion between the barrier layer and the adhesion promoter layer is at least 1.8 N/15 mm, preferably at least 2.2 N/15 mm and especially preferably at least 2.8 N/15 mm. In a particular configuration, the adhesion between the individual layers is sufficiently strong that a carrier layer is torn apart in an adhesion test, called a paperboard fibre tear in the case of a paperboard as carrier layer.

### Adhesion Promoter

Useful adhesion promoters in the intermediate polymer layer include all polymers which are suitable for producing a firm bond through functionalization by means of suitable functional groups, through the forming of ionic bonds or covalent bonds with a surface of a respective adjacent layer. Preferably, these comprise functionalized polyolefins which have been obtained by copolymerization of ethylene with acrylic acids such as acrylic acid, methacrylic acid, crotonic acid, acrylates, acrylate derivatives or carboxylic anhydrides that bear double bonds, for example maleic anhydride, or at least two of these. Among these, preference is given to polyethylene-maleic anhydride graft polymers (EMAH), ethylene-acrylic acid copolymers (EAA) or ethylene-methacrylic acid copolymers (EMAA), which are sold, for example, under the Bynel® and Nucrel®0609HSA trade names by DuPont or Escor®6000ExCo by ExxonMobil Chemicals.

### Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. A further preferred polyolefin is an mPolyolefin (polyolefin prepared by means of a metallocene catalyst). Suitable polyethylenes have a melt flow rate (MFR=MFI−melt flow index) in a range from 1 to 25 g/10 min, preferably in a range from 2 to 20 g/10 min and especially preferably in a range from 2.5 to 15 g/10 min, and a density in a range from 0.910 g/cm³ to 0.935 g/cm³, preferably in a range from 0.912 g/cm³ to 0.932 g/cm³, and further preferably in a range from 0.915 g/cm³ to 0.930 g/cm³.

mPolymer

An mPolymer is a polymer which has been prepared by means of a metallocene catalyst. A metallocene is an organometallic compound in which a central metal atom is arranged between two organic ligands, for example cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two thereof.

### Extrusion

In the extrusion, the polymers are typically heated to temperatures of 210 to 350° C., measured in the molten polymer film beneath the exit from the extruder die. The extrusion can be effected by means of extrusion tools which are known to those skilled in the art and are commercially available, for example extruders, extruder screws, feed blocks, etc. At the end of the extruder, there is preferably an opening through which the polymer melt is expressed. The opening may have any shape that allows extrusion of the polymer melt to the composite precursor. For example, the opening may be angular, oval or round. The opening is preferably in the form of a slot of a funnel. In a preferred configuration of the method, application is effected through a slot. The slot preferably has a length in a range from 0.1 to 100 m, preferably in a range from 0.5 to 50 m, especially preferably in a range from 1 to 10 m. In addition, the slot preferably has a width in a range from 0.1 to 20 mm, preferably in a range from 0.3 to 10 mm, especially preferably in a range from 0.5 to 5 mm. During the application of the polymer melt, it is preferable that the slot and the composite precursor move relative to one another. Preference is given to such a process wherein the composite precursor moves relative to the slot.

In a preferred extrusion coating method, the polymer melt is stretched during the application, this stretching preferably being effected by melt stretching, and most preferably by monoaxial melt stretching. For this purpose, the layer is applied to the composite precursor in the molten state by means of a melt extruder, and the layer applied, which is still in the molten state, is subsequently stretched in the preferably monoaxial direction, in order to achieve orientation of the polymer in this direction. Subsequently, the layer applied is left to cool for the purpose of heat-setting. In this context, it is especially preferable that the stretching is effected by at least the following application steps:
b1. emergence of the polymer melt as a melt film through at least one extruder die slot with an emergence rate Vₒᵤₜ;
b2. application of the melt film to the composite precursor moving relative to the at least one extruder die slot with a movement rate V_{for};
   where Vₒᵤₜ<V_{for}. It is especially preferable that V_{for} is greater than Vₒᵤₜ by a factor in the range from 5 to 200, especially preferably in a range from 7 to 150, further preferably in a range from 10 to 50 and most preferably in a range from 15 to 35. It is preferable here that V_{for} is at least 100 m/min, especially preferably at least 200 m/min and most preferably at least 350 m/min, but typically not more than 1300 m/min. Once the melt layer has been applied to the composite precursor by means of the above-described stretching process, the melt layer is left to cool down for the purpose of heat-setting, this cooling preferably being effected by quenching via contact with a surface which is kept at a temperature in a range from 5 to 50° C., especially preferably in a range from 10 to 30° C.

In a further preferred configuration, the area which has emerged is cooled down to a temperature below the lowest melting temperature of the polymers provided in this area or its flanks, and then at least the flanks of the area are separated from this area. The cooling can be effected in any manner which is familiar to the person skilled in the art and seems to be suitable. Preference is given here too to the heat-setting which has already been described above. Subsequently, at least the flanks are separated from the area. The separation can be conducted in any manner which is familiar to the person skilled in the art and seems to be suitable. Preferably, the separation is effected by means of a knife, laser beam or waterjet, or a combination of two or more thereof, the use of knives being especially preferable, especially knives for shearing.

### Foodstuff

The present sheetlike composite and the container precursor are preferably designed for production of a foodstuff container. In addition, the closed container according to the invention is preferably a foodstuff container. Foodstuffs include all kinds of food and drink known to those skilled in the art for human consumption and also animal feeds. Preferred foodstuffs are liquid above 5° C., for example milk products, soups, sauces, non-carbonated drinks.

### Colourant

According to DIN 55943:2001-10, colourant is the collective term for all colouring substances, especially for dyes and pigments. A preferred colourant is a pigment. A preferred pigment is an organic pigment. Pigments that are notable in connection with the invention are especially the pigments mentioned in DIN 55943:2001-10 and those mentioned in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

### Container

The closed container according to the invention may have a multitude of different forms, but preference is given to an essentially cuboidal structure. In addition, the full area of the container may be formed from the sheetlike composite, or it may have a two-part or multipart construction. In the case of a multipart construction, it is conceivable that, as well as the sheetlike composite, other materials are also used, for example plastic, which can be used particularly in the top or base regions of the container. In this context, however, it is preferable that the container is formed from the sheetlike composite to an extent of at least 50%, especially preferably to an extent of at least 70% and further preferably to an extent of at least 90% of the area. In addition, the container may have a device for emptying the contents. This may be formed, for example, from a polymer or mixture of polymers and be mounted on the outside of the container. It is also conceivable that this device has been integrated into the container by direct injection moulding. In a preferred configuration, the container according to the invention has at least one edge, preferably from 4 to 22 or else more edges, especially preferably from 7 to 12 edges. Edges in the context of the present invention are understood to mean regions which arise in the folding of a surface. Examples of edges include longitudinal contact regions between two wall surfaces of the container in each case, also referred to as longitudinal edges herein. In the container, the container walls are preferably the surfaces of the container framed by the edges. Preferably, the interior of a container according to the invention comprises a foodstuff. Preferably, the closed container does not comprise any lid or base, or either, that has not been formed in one piece with the sheetlike composite. A preferred closed container comprises a foodstuff.

### Test Methods

The test methods which follow were utilized within the context of the invention. Unless stated otherwise, the measurements were conducted at an ambient temperature of 23° C., an ambient air pressure of 100 kPa (0.986 atm) and a relative air humidity of 50%.

### MFR

MFR is measured according to standard ISO 1133 (unless stated otherwise at 190° C. and 2.16 kg).

### Density

Density is measured according to standard ISO 1183-1.

### Melting Temperature

Melting temperature is determined on the basis of the DSC method ISO 11357-1, -5. The instrument is calibrated according to the manufacturer's instructions on the basis of the following measurements:
temperature indium—onset temperature,
heat of fusion indium,
temperature zinc—onset temperature.

### Oxygen Permeation Rate

Oxygen permeation rate is determined according to standard ISO 14663-2 Appendix C at 20° C. and 65% relative air humidity.

### Moisture Content of Paperboard

Moisture content of paperboard is measured according to standard ISO 287:2009.

### Adhesion

The adhesion of two adjacent layers is determined by fixing them in a 90° peel test instrument, for example the Instron “German rotating wheel fixture”, on a rotatable roller which rotates at 40 mm/min during the measurement. The samples had been cut beforehand into strips of width 15 mm. On one side of the sample, the laminas are detached from one another and the detached end is clamped in a tensile device directed vertically upward. A measuring instrument to determine the tensile force is attached to the tensile device. As the roller rotates, the force needed to separate the laminas from one another is measured. This force corresponds to the adhesion of the layers to one another and is reported in N/15 mm. The separation of the individual layers can be effected mechanically, for example, or by means of a controlled pretreatment, for example by soaking the sample in 30% acetic acid at 60° C. for 3 min.

### Detection of Colourants

Detection of organic colourants can be conducted in accordance with the methods described in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

### Transmission and Absorption

Three specimens of the sheetlike composite having dimensions of 4 cm×4 cm are introduced into an acetic acid bath (30% acetic acid solution: 30% by weight of CH₃COOH, remainder to 100% by weight H₂O) for 30 minutes at 60° C. This results in detachment of the outer polymer layer from the carrier layer. Residues of the carrier layer on the outer polymer layer are removed with a brush. Three 4 cm² specimens are cut out of the film thus prepared. These are then stored at 23° C. for 4 hours and hence dried.

Each of the three specimens is placed into a UV-vis spectrometer (Analytik Jena Specord 250 Plus) and analysed. Subsequently, transmission is determined over a wavelength in the range from 200 to 800 nm with a measurement point separation of 2 nm and a speed of 8 nm/s. The transmittance T is

T=(I/I₀)

with
I₀=light intensity before passing through the sample and
I=light intensity after passing through the sample.

The measurement is repeated three times for each specimen and the arithmetic mean is calculated. The absorbance A is calculated according to the equation:

A=1−T−R

### Reflectance R

In this measurement, a Specord 250 PLUS UV-vis spectrometer with a reflection insert with variable angle is used in reflection mode. The measuring angle is 40° over a wavelength range from 300 to 1100 nm with a measurement point separation of 2 nm and a speed of 10 nm/s and a gap width of 4 nm. The measurement is repeated three times for each sample and the arithmetic mean is calculated.

### Gloss

Gloss is measured with a micro-gloss 60° gloss meter from BYK-Gardner. To perform the gloss measurement, a 3 cm×10 cm specimen is cut out of the sheetlike composite. The gloss meter is placed onto the sample at right angles to the direction of ink or lacquer application and 6 measurements are conducted at different points in print direction. The average value of the 6 measurements gives the test result.

### Aspect Ratio

The aspect ratio of the inorganic particles is determined with a light microscope or scanning electron microscope.

### Colour Bond Strength

The bond strength of a colour layer is understood to mean the resistance of the colour layer to forces that occur when an adhesive strip is torn off the surface of the colour layer. The adhesive strip used in the test is Tesaband 4104 adhesive tape, width 20 mm, from the manufacturer Beiersdorf AG, Hamburg. The sample to be tested is placed with the colour layer upward on a hard, smooth and flat base. For each test run, a strip of the Tesaband 4104 adhesive tape is stuck onto the outer layer at least over a length of 30 mm and pressed on homogeneously by thumb. The test is effected within 30 seconds after the Tesafilm adhesive tape has been stuck on. Longer residence times on the outer layer can lead to different results. The test is effected either in that
a) the adhesive strip is pulled off sharply at an angle of 90°, or
b) the adhesive strip is pulled off by gradual peeling (at an angle of less than 45° relative to the colour layer).

For each of the two test methods a) and b), 3 test runs are conducted at different positions of the colour layer. The results are assessed by the naked eye using the scale below. The results improve from 1 to 5:

5—colour layer not pulled off
4—spots of colour layer pulled off at individual sites
3—colour layer pulled off significantly at individual sites
2—colour layer pulled off over large areas
1—colour layer pulled off completely, based on the area of the adhesive strip

These 6 results are used to form the arithmetic mean, which corresponds to the result of the measurement.

### Opening Test

The carrier layer was provided with a hole to which an opening aid according to EP1 812 298 B1 was applied. According to paragraph [0002], this opens the container with a puncturing and cutting motion through the membrane that covers the hole. In the case of optimal function, about 90% of the membrane radius defined by the cutting ring is cut through, and there is only a connection to the container at one site. The membrane folds away to the side and the product can be poured out without disruption. In the event of material selection not in accordance with the invention, restrictions can arise in the opening of the container. In each case, the symbols mean:

“++” very good opening characteristics,
“+” good opening characteristics,
“−” poor opening characteristics and
“−−” very poor opening characteristics.

Poor or very poor opening characteristics can mean high expenditure of force, a membrane that has not been completely cut through, or threads and projections resulting from stretched polymer layers.

The invention is illustrated further by way of example hereinafter by examples. The invention is not restricted to the examples.

For the examples, laminates with the layer structure and layer sequence which follows were produced by a layer extrusion method.

| Layer designation | Material | Grammage [g/m²] |
|---|---|---|
| Outer polymer layer | see below | |
| Carrier layer | Paperboard: Stora Enso Natura T Duplex | 191 |
| | twice-coated, Scott bond 200 J/m² | |
| Lamination layer | LDPE 23L430 from Ineos GmbH, | 20 |
| | Cologne | |
| Barrier layer | aluminium, EN AW 8079 from Hydro | here thickness 6 μm |
| | Aluminium Deutschland GmbH | |
| Inner polymer layer | LDPE 19N430 from Ineos GmbH, | 40 |
| (103) | Cologne | |

### Masterbatch Production

For production of the masterbatches, mica effect pigments of the Iriodin 111 or Iriodin 123 type from Merck KGaA, Darmstadt, are processed together with pure LDPE of the 23L430 type, from Ineos GmbH, Cologne, in a conventional compounding extruder to give a compound having a pigment content of 20% by weight. The carbon black is metered in separately in the form of a further commercial olefin-based masterbatch with carbon black content 1% by weight in the laminate production described hereinafter.

### Laminate Production

The laminate is produced with an extrusion coating system from Davis Standard. In the first step, the outer polymer layer is applied to the carrier layer. In the second step, the lamination layer is applied together with the barrier layer to the carrier layer that has been coated with the outer polymer layer beforehand. In the last step, the inner polymer layer is applied to the barrier layer. For application of the individual layers, the polymers or polymer blends are melted in an extruder. In the case of application of one polymer or polymer blend in a layer, the resultant melt is transferred via a feed block into a nozzle and extruded onto the carrier layer. In the case of application of two or more polymers or polymer blends in a layer, the resultant melts are combined by means of a feed block and then co-extruded onto the carrier layer. The different outer polymer layers in the examples and comparative examples were examined by the test method described above with regard to their reflection, absorption and gloss properties. In addition, the colour adhesion on the respective outer layers was characterized with the aid of the above-described bond strength test.

### COMPARATIVE EXAMPLES A (NON-INVENTIVE)

| | Reflectance | | | |
|---|---|---|---|---|
| Composition of the | (angle = 40°, 600 | Mean gloss at | Colour bond | Opening |
| outer polymer layer | to 800 nm) | 60° [GU] | strength | test |
| LDPE 23L430 from | 2% to 3% | 22.6 | 2 | −− |
| Ineos, layer thickness 14 μm, | | | | |
| proportion of the | | | | |
| mica or carbon black | | | | |
| particles: 0% by | | | | |
| weight/0% by weight | | | | |

### EXAMPLES 1 (INVENTIVE)

| | Reflectance | | | |
|---|---|---|---|---|
| Composition of the | (angle = 40°, 600 | Mean gloss at | Colour bond | Opening |
| outer polymer layer | to 800 nm) | 60° [GU] | strength | test |
| LDPE 23L430 from | 6% to 7% | 65.1 | 4 | + |
| Ineos (layer thickness 16 μm) | | | | |
| with 7.5% by | | | | |
| weight of Iriodin 111 | | | | |
| from Merck and 0.01% | | | | |
| by weight of carbon | | | | |
| black | | | | |

### EXAMPLES 2 (INVENTIVE)

| | Reflectance | | | |
|---|---|---|---|---|
| Composition of the | (angle = 40°, 600 | Mean gloss at | Colour bond | Opening |
| outer polymer layer | to 800 nm) | 60° [GU] | strength | test |
| LDPE 23L430 from | 5% to 6% | 65 | 4 | ++ |
| Ineos (layer thickness 18 μm) | | | | |
| with 7.5% by | | | | |
| weight of Iriodin 111 | | | | |
| from Merck and 0.08% | | | | |
| by weight of carbon | | | | |
| black | | | | |

### EXAMPLES 3 (INVENTIVE)

| | Reflectance | | | |
|---|---|---|---|---|
| Composition of the | (angle = 40°, 600 | Mean gloss at | Colour bond | Opening |
| outer polymer layer | to 800 nm) | 60° [GU] | strength | test |
| LDPE 23L430 from | 5.5% to 6.5% | 66.5 | 4 | ++ |
| Ineos (layer thickness 28 μm) | | | | |
| with 7.5% by | | | | |
| weight of Iriodin 111 | | | | |
| from Merck and 0.08% | | | | |
| by weight of carbon | | | | |
| black | | | | |

### EXAMPLES 4 (INVENTIVE)

| | Reflectance | | | |
|---|---|---|---|---|
| Composition of the | (angle = 40°, 600 | Mean gloss at | Colour bond | Opening |
| outer polymer layer | to 800 nm) | 60° [GU] | strength | test |
| LDPE 23L430 from Ineos | 5.5% to 7% | 67.8 | 4 | ++ |
| (layer thickness 18 μm) | | | | |
| with 7.5% by weight of | | | | |
| Iriodin 123 from Merck | | | | |
| and 0.08% by weight of | | | | |
| carbon black | | | | |

### EXAMPLES 5 (INVENTIVE)

| | Reflectance | | Colour | |
|---|---|---|---|---|
| Composition of the | (angle = 40°, 600 | Mean gloss at | bond | Opening |
| outer polymer layer | to 800 nm) | 60° [GU] | strength | test |
| LDPE 23L430 from | 5.5% to 7% | 61.3 | 5 | + |
| Ineos (layer thickness 18 μm) | | | | |
| with 5% by weight | | | | |
| of Iriodin 123 from | | | | |
| Merck and 0.08% by | | | | |
| weight of carbon black | | | | |

### Evaluation

The above test data demonstrate that, with the laminates according to the invention, it is possible to obtain dimensionally stable foodstuff containers having an improved metallic impression, especially a metallic gloss effect. In addition, it is possible using the laminate according to the invention to produce foodstuff containers having better openability. Moreover, the laminates of the invention have better printability, since the printing ink adheres better.

The figures show, in schematic form and not to scale, unless stated otherwise in the description or the respective figure:

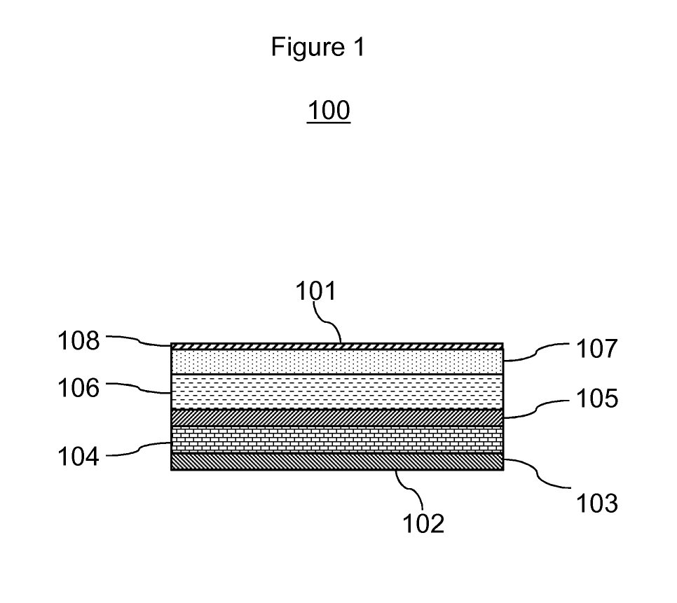

FIG. 1 a sheetlike composite according to the invention in a cross section;

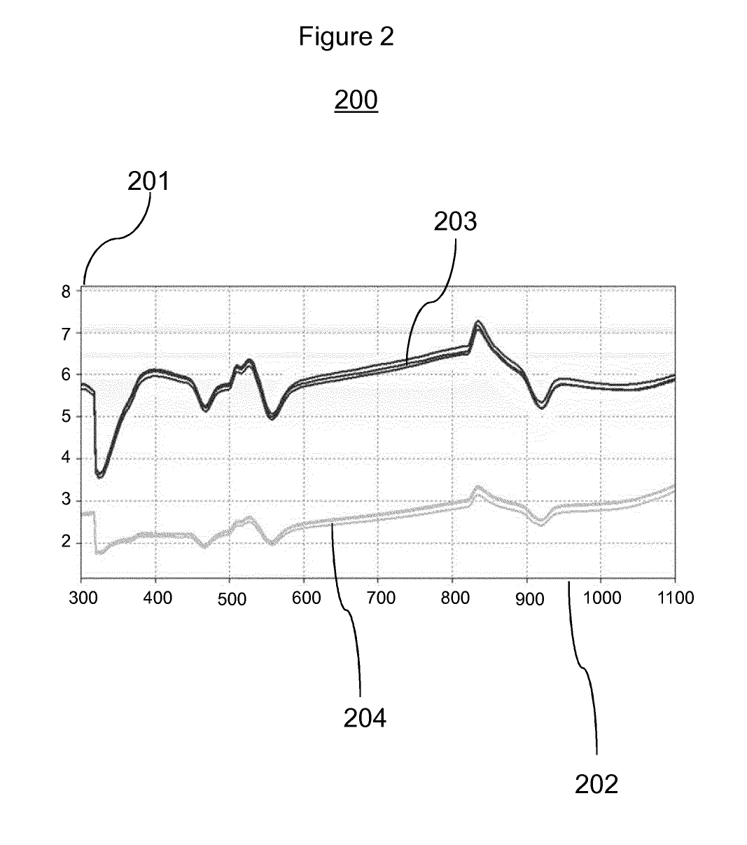

FIG. 2 spectrograms;

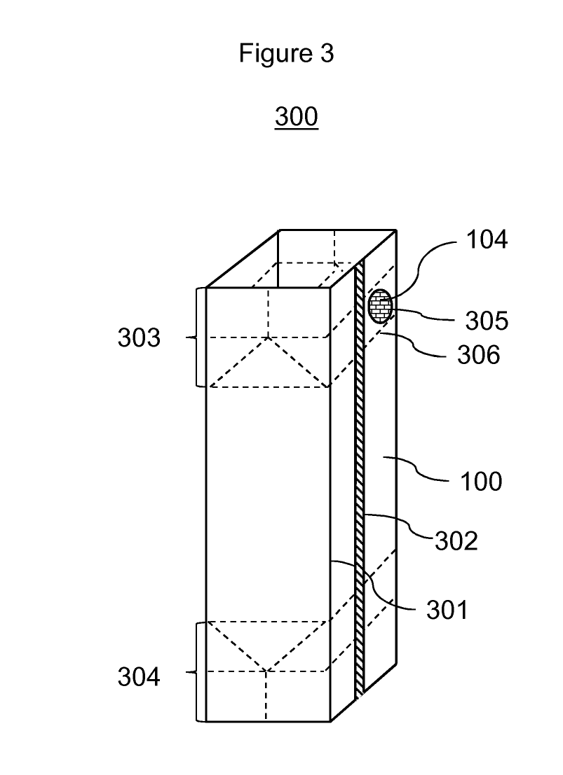

FIG. 3 a container precursor according to the invention;

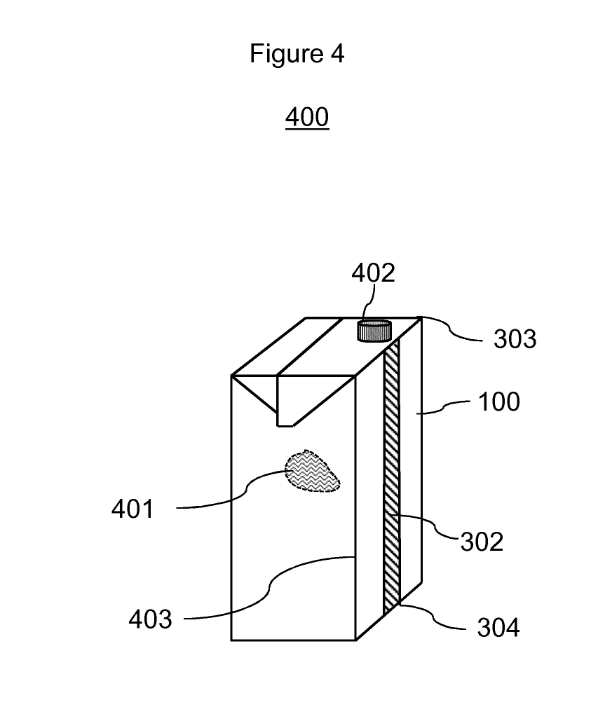

FIG. 4 a closed container according to the invention;

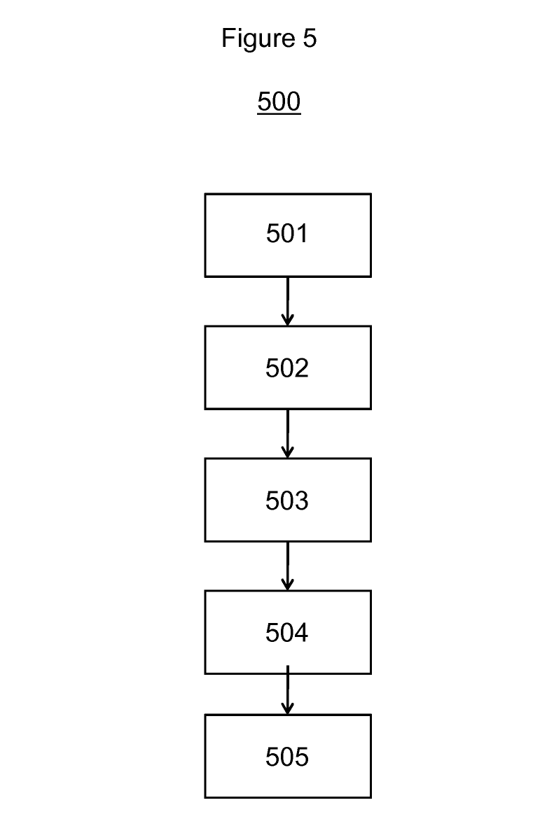

FIG. 5 a flow diagram of a method according to the invention;

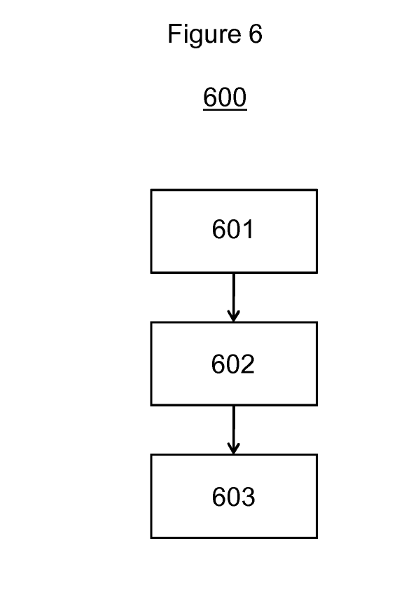

FIG. 6 a flow diagram of a further method according to the invention; and

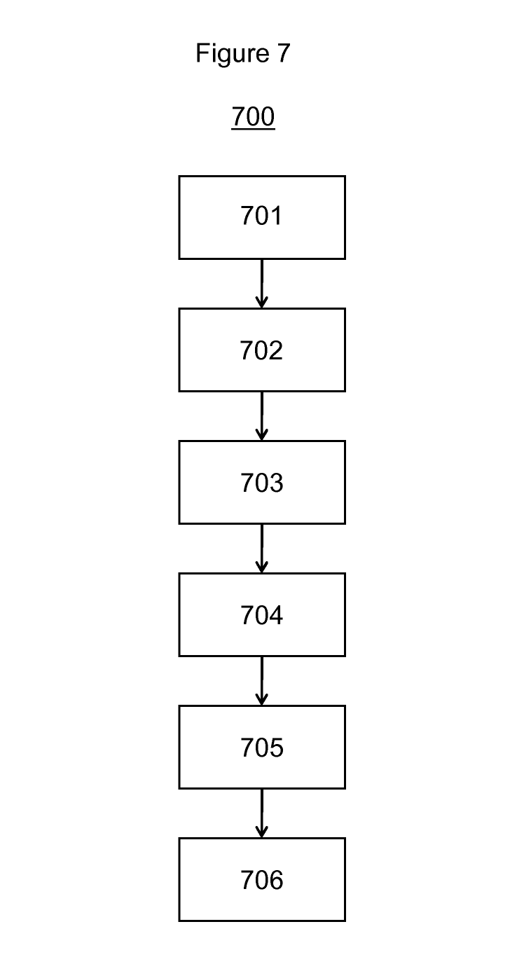

FIG. 7 a flow diagram of a further method according to the invention.

FIG. 1 shows a sheetlike composite 100 according to the invention in a cross section. The sheetlike composite 100 comprises, as layers of a layer sequence in the direction from an outer face 101 of the sheetlike composite 100 to an inner face 102 of the sheetlike composite 100, an colour layer 108, an outer polymer layer 107 composed of LDPE, wherein the outer polymer layer has a reflectance in a range of 5.5% to 6.5% for light of wavelengths in a range from 600 to 800 nm at an angle of 40°; a carrier layer 106 composed of paperboard; an intermediate polymer layer 105 as lamination layer, consisting of LDPE 23L430 from Ineos GmbH, Cologne; a barrier layer 104 composed of aluminium; and an inner polymer layer 103. A graph 203 of a reflection measurement of the composite according to the invention is shown in FIG. 2.

FIG. 2 shows a spectrogram 200. This comprises graphs 203 of reflection measurements on sheetlike composites 100 according to the invention and graphs 204 of reflection measurements on sheetlike composites not according to the invention. In these graphs, the abscissa axis shows the wavelength in nm and the ordinate axis the reflectance in %. It is apparent that the reflectance of the graphs 203 is between 5.5% and 7% in a wavelength range from 600 to 800 nm. The reflection measurements for the graphs 203 were conducted on a sheetlike composite 100 according to the invention, wherein the outer polymer layer 107 comprises Iriodin 123 from Merck to an extent of 5.0% by weight, based on the weight of the outer polymer layer, and carbon black to an extent of 0.08% by weight, based on the weight of the outer polymer layer. The remainder of this outer polymer layer 107 to 100% by weight consists of LDPE 23L430 from Ineos GmbH, Cologne. This outer polymer layer 107 has a grammage of 20 g/m². In addition, the reflectance of the graphs 204 for a sheetlike composite not according to the invention in a wavelength range from 600 to 800 nm is always below 3.5%. The measurements were conducted by the “Reflectance R” test method described herein.

FIG. 3 shows a container precursor 300 according to the invention. The container precursor 300 comprises the sheetlike composite 100 of FIG. 1 with 4 folds 301. The sheetlike composite 100 is a blank for production of a single closed container 400. The container precursor 300 is in the form of a sleeve and comprises a longitudinal seam 302 in which a first longitudinal edge and a further longitudinal edge of the sheetlike composite 100 are sealed to one another. In addition, the container precursor 300 comprises a hole 305 in the carrier layer 106. The hole 305 is covered by the intermediate polymer layer 105, the barrier layer 104 and the inner polymer layer 103. By folding along creases 306 and joining of fold regions in a top region 303 and a base region 304 of the container precursor 300, a closed container 400 is obtainable. Such a closed container 400 is shown in FIG. 4.

FIG. 4 shows a closed container 400 according to the invention. The closed container 400 has been produced from the container precursor 300 according to FIG. 3. The closed container 400 comprises a foodstuff

401 and has 12 edges 403. In addition, the closed container 400 is joined to an opening aid 402 which covers the hole 305 on the outer face 101 of the sheetlike composite 100. Here, the opening aid 402 comprises a lid and a cutting tool connected to the lid within the interior thereof.

FIG. 5 shows a flow diagram of a method 500 according to the invention for production of a sheetlike composite 100. In a method step a) 501, a sheetlike composite precursor consisting of a carrier layer 106 composed of paperboard, an intermediate polymer layer 105 as lamination layer and a barrier layer 104 composed of aluminium is provided in the form of a roll. In a method step b) 502, a first composition comprising a first amount of a polymer, here an LDPE 23L430 from Ineos GmbH, Cologne, and a multitude of inorganic particles of a first kind, here Iriodin 111 from Merck, is provided. In a method step c) 503, a second composition, here a carbon black masterbatch FC7302 NG from Polyplast Müller, Straelen, is provided. In a method step d) 504, the first composition is mixed with the second composition and a third amount of the LDPE 23L430 from Ineos GmbH, Cologne, in an extruder thereby obtaining a third composition. In a method step e) 505, the third composition is applied on a side of the carrier layer 106 remote from the barrier layer 104 thereby obtaining an outer polymer layer 107.

FIG. 6 shows a flow diagram of a further method 600 according to the invention for production of a container precursor 300. In a method step A. 601, the sheetlike composite 100 according to FIG. 1 is provided. This comprises a first longitudinal edge and a further longitudinal edge. In a method step B. 602, the sheetlike composite 100 is folded. In a method step C. 603, the first longitudinal edge and the further longitudinal edge are pressed against one another and joined to one another by heat-sealing. Thus, a longitudinal seam 302 is obtained. According to the above description, the container precursor 300 is produced according to FIG. 3.

FIG. 7 shows a flow diagram of a further method 700 according to the invention for production of a closed container 400. In a method step a. 701, the container precursor 300 according to FIG. 3 is provided. In a method step b. 702, a base region 304 of the container precursor 300 is formed by folding the sheetlike composite 100. In a method step c. 703, the base region 304 is closed by sealing with hot air at a temperature of 300° C. In a method step d. 704, the container precursor 300 is filled with a foodstuff 401 and, in a method step e. 705, the container precursor 300 is closed by sealing in a top region 303 thereby obtaining the closed container 400. In a method step f. 706, the closed container 400 is joined to an opening aid 402.

### LIST OF REFERENCE SYMBOLS

100 sheetlike composite according to the invention
101 outer face
102 inner face
103 inner polymer layer
104 barrier layer
105 intermediate polymer layer
106 carrier layer
107 outer polymer layer
108 colour layer
200 spectrograms
201 reflectance in %
202 wavelength in nm
203 graph for a laminate according to the invention
204 graph for a laminate not according to the invention
300 container precursor according to the invention
301 fold
302 longitudinal seam
303 top region
304 base region
305 hole
306 crease
400 closed container according to the invention
401 foodstuff
402 opening aid
403 edge
500 method according to the invention for production of a sheetlike composite
501 method step a)
502 method step b)
503 method step c)
504 method step d)
505 method step e)
600 method according to the invention for production of a container precursor
601 method step A.
602 method step B.
603 method step C.
700 method according to the invention for production of a closed container
701 method step a.
702 method step b.
703 method step c.
704 method step d.
705 method step e.
706 method step f.

1. A sheetlike composite comprising, as layers of a layer sequence, from an outer face of the sheetlike composite to an inner face of the sheetlike composite,
a) an outer polymer layer comprising
i) a polymer matrix, and
ii) a multitude of inorganic particles;
b) a carrier layer;
c) a barrier layer; and
d) an inner polymer layer;
wherein the outer polymer layer superposed on the carrier layer is characterized by a reflectance for a reflection of light having a wavelength in a range from 600 to 800 nm according to the test method described herein in a range from 4% to 8%.

2. The sheetlike composite according to claim 1, wherein the outer polymer layer is characterized by a grammage in a range from 5 to 75 g/m².

3. The sheetlike composite according to claim 1, wherein the outer polymer layer comprises the multitude of inorganic particles in an overall proportion in a range from 1% to 15% by weight, based on the total weight of the outer polymer layer.

4. The sheetlike composite according to claim 1, wherein the multitude of inorganic particles comprises
a) a first kind of inorganic particles in a first proportion by weight, based on the total weight of the outer polymer layer, and
b) a further kind of inorganic particles in a further proportion by weight, based on the total weight of the outer polymer layer,
where a ratio of the first proportion by weight to the further proportion by weight is in a range from 60:1 to 1000:1.

5. The sheetlike composite according to claim 4, wherein the first proportion by weight is in a range from 1% to 15% by weight, based on the total weight of the outer polymer layer.

6. The sheetlike composite according to claim 4, wherein the further proportion by weight is in a range from 0.001% to 1% by weight, based on the total weight of the outer polymer layer.

7. A container precursor comprising the sheetlike composite (100) according to claim 1.

8. A closed container comprising the sheetlike composite according to claim 1.

9. A method comprising, as method steps,
a) providing a sheetlike composite precursor comprising, as layers of a layer sequence,
i) a carrier layer, and
ii) a barrier layer;
b) providing a first composition comprising, as constituents,
i) a first amount of a polymer, and
ii) a multitude of inorganic particles of a first kind;
c) providing a second composition comprising, as constituents,
i) a second amount of the polymer, and
ii) a multitude of inorganic particles of a further kind;
d) contacting the first composition and the second composition with a third amount of the polymer thereby obtaining a third composition; and
e) superposing the third composition on the carrier layer, on a side of the carrier layer remote from the barrier layer, thereby obtaining an outer polymer layer.

10. A sheetlike composite obtainable by the method according to claim 9.

11. A method comprising, as method steps,
A. providing the sheetlike composite according to claim 1, comprising a first longitudinal edge and a further longitudinal edge;
B. folding the sheetlike composite; and
C. contacting and joining the first longitudinal edge to the further longitudinal edge thereby obtaining a longitudinal seam.

12. A container precursor obtainable by the method according to claim 11.

13. A method comprising, as method steps,
providing the container precursor according to claim 7;
b. forming a base region of the container precursor by folding the sheetlike composite;
c. closing the base region;
d. filling the container precursor with a foodstuff, and
e. closing the container precursor in a top region thereby obtaining a closed container.

14. A closed container obtainable by the method according to claim 13.

15. A use of the sheetlike composite according to claim 1 for production of a closed container filled with a foodstuff.

16. A use of
a) a first composition comprising, as constituents,
i) a first amount of a polymer, and
ii) a multitude of a inorganic particles of a first kind; and
b) a second composition comprising, as constituents,
i) a second amount of the polymer, and
ii) a multitude of inorganic particles of a further kind for production of a packaging material laminate for dimensionally stable foodstuff containers;
wherein the first composition comprises the inorganic particles of the first kind in a proportion in a range from 5% to 30% by weight, based on the total weight of the first composition;
wherein the second composition comprises the inorganic particles of the further kind in a proportion in a range from 0.01% to 1.5% by weight, based on the total weight of the second composition;
wherein each of the inorganic particles of the first kind comprises a core comprising a silicate or a silicon oxide or both, and a shell superposed on the core, comprising an oxide of a first metal other than silicon;
wherein the inorganic particles of the further kind comprise carbon in a proportion of at least 50% by weight, based on the weight of the inorganic particles of the further kind.
